(19) United States
(12) Patent Application Publication
(10) Pub. No.: US 2018/0201033 A1
(43) Pub. Date: Jul. 19, 2018

(54) Hot Air Circulating System for Printing Press

(71) Applicant: Nanjing Suote Packaging Products Co., Ltd, Nanjing (CN)

(72) Inventor: Zihong WANG, Nanjing (CN)

(21) Appl. No.: 15/588,568

(22) Filed: May 5, 2017

(30) Foreign Application Priority Data
Jan. 19, 2017 (CN) 201710038449.0

(51) Int. Cl. B41J 11/00; B41J 29/377

(52) U.S. Cl. CPC B41J 11/0015; B41J 29/377

(57) ABSTRACT

Disclosed is a hot air circulating system for printing press, which comprises a plurality of primary air blowers and a plurality of primary heating devices connected at air suction openings of the primary air blowers. Air blowing openings of the primary air blowers are in communication with printing presses through primary air blowing passages, primary air suction passages are connected between the primary heating devices and the printing presses, and the primary air suction passages are provided thereon with a plurality of air discharging passages. With the disclosure, losses of thermal energy are effectively reduced, thin films are prevented from being deformed due to temperature shock, thus improving the rate of finished products and reducing pollution caused to production workshops.

### FIELD OF THE INVENTION

The present invention relates to the field of printing equipment, and in particular, to a hot air circulating system for printing press.

### BACKGROUND OF THE INVENTION

Printed products need to be oven dried timely to ensure printing quality after printing by printing equipment.

An efficient and energy-saving printing drying machine is disclosed in a Chinese Invention Patent filed on Sep. 17, 2013 with an application publication number of CN103481659A, which mainly comprises a compressor, heat exchangers and an air supplying blower that are sequentially connected to form a fluorine path cycle.

However, the above patent structure, like the present printing press equipment, discharges waste air in a continuous manner. Discharged waste air takes away some heat, and thus leads to losses of thermal energy. On the other hand, due to discharging of hot air, an air blower needs to be kept at high power so as to maintain the circulation velocity of air, which increases power consumption of the system.

### SUMMARY OF THE INVENTION

An object of the present invention is to provide a hot air circulating system for printing press, wherein the hot air circulating system for printing press utilizes inner circulation of air to achieve zero-discharge of heat so as to save energy consumed by the drying of the printing press.

The above technical object of the present invention is realized by the following technical solution: a hot air circulating system for printing press, wherein the hot air circulating system for printing press comprises a plurality of primary air blowers and a plurality of primary heating devices connected at air suction openings of the primary air blowers, wherein air blowing openings of the primary air blowers are in communication with printing presses through primary air blowing passages, and primary air suction passages are connected between the primary heating devices and the printing presses.

With the above technical solution adopted, airflow circulation is formed among the primary air blowers, the primary heating devices and the printing presses. Airflow is heated by the primary heating devices, and blown by the primary air blowers into the printing presses to dry thin films after printing. Finally, on the other sides of the primary air blowers, the airflow is sucked by negative pressure into the primary heating devices for airflow circulation. In this manner, heat is ensured to be utilized to the greatest extent, which effectively avoids losses of thermal energy. Meanwhile, workshops will not be polluted due to the discharging of hot air, thus making the present system more environmentally friendly.

The present invention is further configured as follows: the primary air suction passages comprise first buffer sections bent as U-shaped.

With the above technical solution adopted, multi-section bending on the buffer sections reduces the velocity of re-flowing air, such that the duration of stay of the re-flowing air in the heating devices is relatively prolonged to improve heating effects of the heating devices on the re-flowing air.

The present invention is further configured as follows: the first buffer sections are horizontally disposed, wherein one end of each first buffer section is connected on the primary heating device, while the other end is connected to a vertically disposed L-shaped tube, and thus second buffer sections are formed, wherein the second buffer sections are connected with the printing presses.

With the above technical solution adopted, the first buffer sections are located on the horizontal plane as a whole, while the second buffer sections are located on the vertical plane. In this manner, while the first and second buffer sections are in communication with each other, re-flowing airflow will collide with tube walls in a greater number of directions during its circulation in the first and second buffer sections so as to strengthen condensing and drying effects of the primary air suction passages.

The present invention is further configured as follows: the second buffer sections are connected with the primary heating devices through straight tubes, wherein the straight tubes are provided thereon with pressure regulating valves for opening and closing the straight tubes.

With the adoption of the above technical solution, as airflow in the first and second buffer sections will lose some kinetic energy during its circulation as a result of collision with tube walls, the primary air blowers will be in a state similar to overloading, such that the amount of air in the primary air blowing passages is insufficient. Under such case, the pressure regulating valves in the straight tubes may be opened to reduce the circulation formation of re-flowing air in the primary air suction passages so as to supplement the air blown by the primary air blowers.

The present invention is further configured as follows: secondary air blowers and secondary heating devices connected at air suction openings of the secondary air blowers are further comprised, wherein air blowing openings of the secondary air blowers are in communication with the printing presses through secondary air blowing passages, and the secondary heating devices are in communication with the printing presses through secondary air suction passages.

With the above technical solution adopted, a hot air auxiliary circulating system is formed by such structures as the secondary air blowers and the secondary heating devices so as to improve air circulation efficiency in the printing presses and strengthen drying effects on thin films.

The present invention is further configured as follows: the printing presses are provided therein with carrying roller groups for delivering thin films, wherein front surfaces of the thin films are printing surfaces, wherein each primary air blowing passage and each secondary air blowing passage are located on one side of the printing surface of the thin film, and each primary air suction passage and each secondary air suction passage are likewise located on one sides of the printing surface of the thin film.

With the above technical solution adopted, airflow entering into and discharging out of drying chambers flows past the printing surfaces of the thin films, thus effectively improving the drying effects of the airflow on the thin films.

The present invention is further configured as follows: the primary air blowing passages, the secondary air blowing passages, the primary air suction passages and the secondary air suction passages are provided thereon with flow control valves, respectively.

With the above technical solution adopted, the flow control valves are utilized to control the flows of airflow in various passages so as to accommodate different printing requirements.

The present invention is further configured as follows: the primary air suction passages are provided thereon with a plurality of air discharging pipes for discharging air to the outside of a workshop.

With the above technical solution adopted, the air discharging pipes are disposed to discharge some re-flowing air from the hot air circulating system so as to reduce the amount of printing dust accumulated in the process of hot air circulation and avoid gas explosion and hazards caused by excessive toxicity in the air.

The present invention is further configured as follows: the air discharging pipes are also provided thereon with flow control valves.

With the above technical solution adopted, the amount of air discharged from the air discharging pipes may be regulated to accommodate different operation requirements of the printing presses.

The present invention is further configured as follows: the flow control valves are solenoid valves; a PLC control module is also provided for controlling the flow control valves and adjusting the frequencies of the primary air blowers, the primary heating devices, the secondary air blowers and the secondary heating devices.

With the above technical solution adopted, the PLC control module is utilized to achieve automatic control of various elements in the hot air circulating system so as to realize intelligentized adjustment.

Compared with the prior art, the hot air circulating system for printing press provided by the present invention has the following advantages:

1. Hot air is circulated internally, which effectively reduces losses of thermal energy, thus making the whole equipment more energy-saving;

2. The circulation of hot air effectively improves drying effects on thin films, such that printing presses are not required to be added with cooling rollers. In this manner, thin films are prevented from being deformed due to temperature shock, thus improving the rate of finished products;

3. The pigment solution still exists in the whole airflow circulating system even after volatilization in the drying process, which effectively reduces the environmental pollution inside and outside of the workshop caused by the volatilization of the solution along with the flowing of hot air.

### BRIEF DESCRIPTION OF THE DRAWINGS

FIG. 1 schematically shows the structure of a printing unit in embodiment 1;

FIG. 2 schematically shows a printing press and a hot air circulating system in embodiment 1;

FIG. 3 schematically shows a primary air suction tube in embodiment 2;

FIG. 4 schematically shows a straight tube in embodiment 2;

FIG. 5 schematically shows the structures of a primary hot air circulation and an auxiliary hot air circulation in embodiment 3;

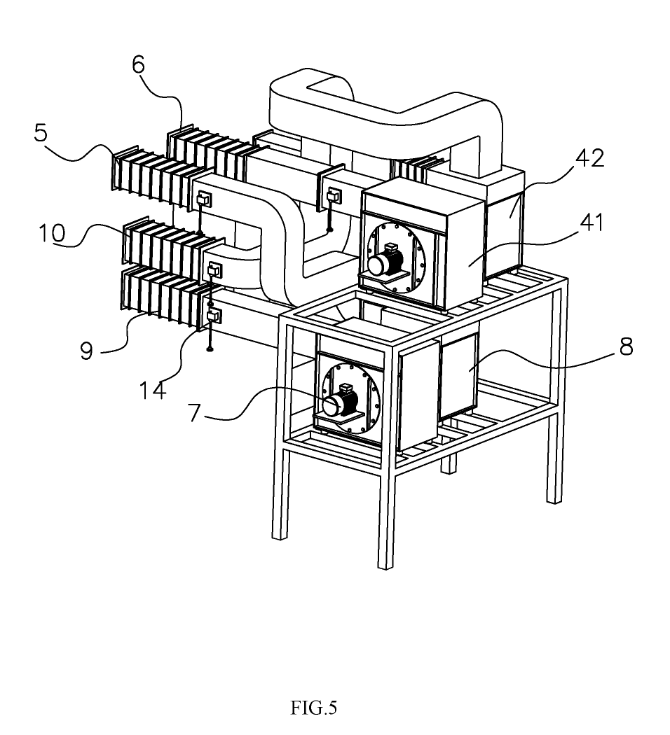

FIG. 6 schematically shows the arrangement structure of various pipes in embodiment 1.

In the drawings, 1 indicates a printing press; 2 indicates a drying chamber; 3 indicates a PLC control module; 4 indicates a primary hot air circulating system; 41 indicates a primary air blower; 42 indicates a primary heating device; 5 indicates a primary air blowing passage; 6 indicates a primary air suction passage; 61 indicates a first buffer section; 62 indicates a second buffer section; 63 indicates a straight tube; 7 indicates a secondary air blower; 8 indicates a secondary heating device; 9 indicates a secondary air blowing passage; 10 indicates a secondary air suction passage; 11 indicates a straight tube; 12 indicates a delivering roller; 13 indicates a thin film; and 14 indicates a control valve.

### DETAILED DESCRIPTION OF THE PREFERRED EMBODIMENTS

The present invention will be further illustrated below in detail in conjunction with the accompanying drawings.

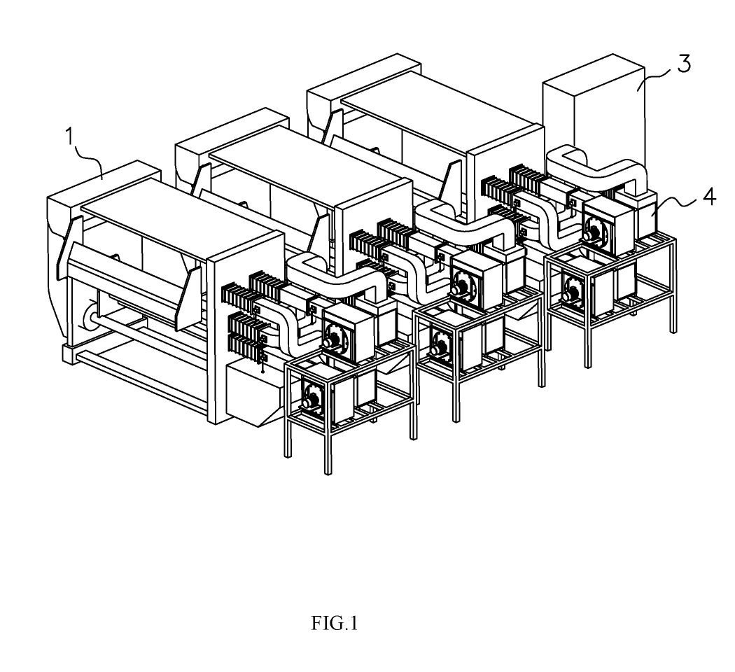

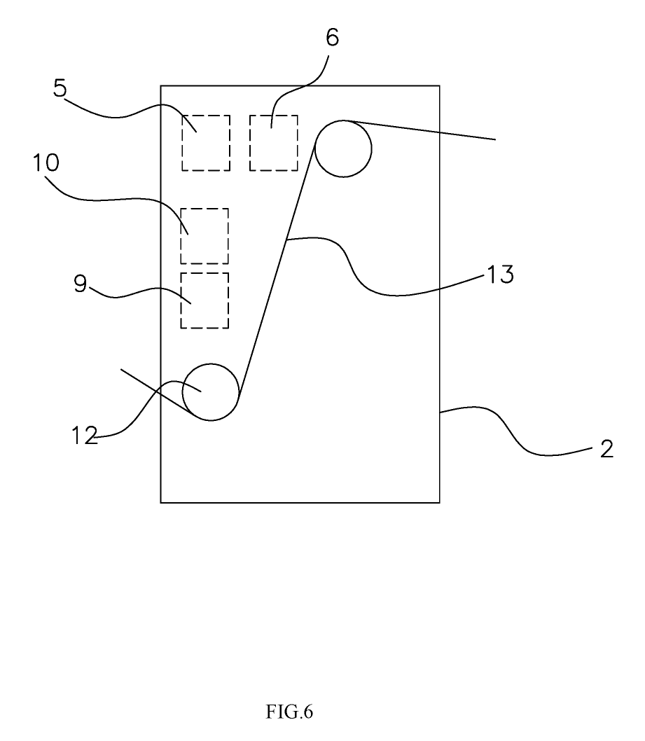

Embodiment 1: a thin film printing production line is provided, and referring to FIGS. 1 and 6 of the description, the thin film printing production line comprises a plurality of printing presses 1. The printing presses 1 in this case are refitted from the printing unit having a model number of HTYJMD10-1050 and produced by Jiangyin Huitong Packing Machinery Co., Ltd. A drying chamber 2 is disposed above each of the printing presses 1, and the drying chamber 2 is provided therein with a plurality of delivering rollers 12 for transferring a thin film 13 after printing.

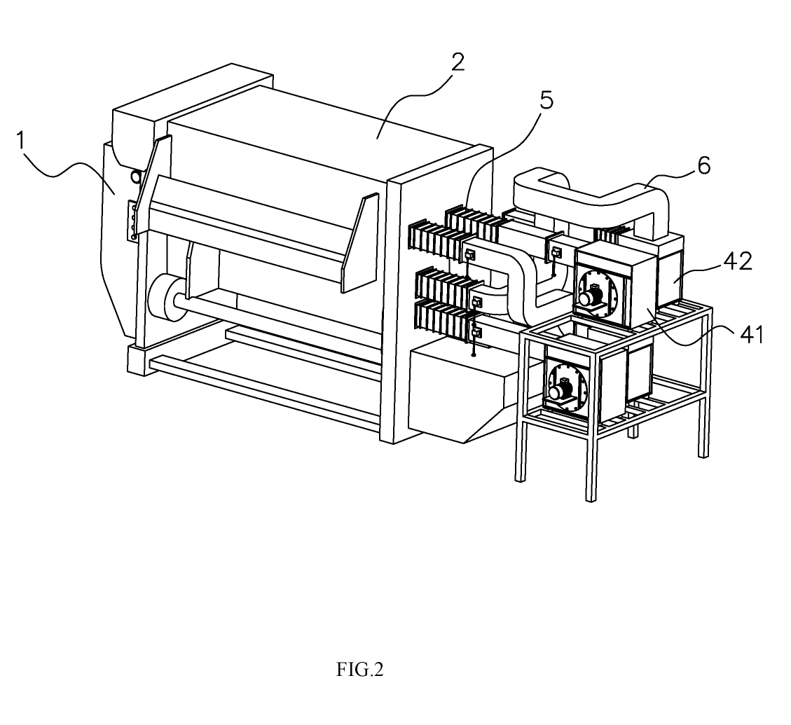

Referring to FIGS. 2 and 6, a primary hot air circulating system 4 is mounted on the lateral side of each of the printing presses 1. The primary hot air circulating system 4 comprises a primary air blower 41 and a primary heating device 41, wherein both the primary air blower 41 and the primary heating device 41 are not only one in number, and they can be increased in number according to actual requirements. Explanation is made below with one primary air blower 41 and one primary heating device 41 as an example. The primary heating device 41 using thermocouple as its heating source is connected at an air suction opening of the primary air blower 41. A primary air blowing passage 5 is connected between an air blowing opening of the primary air blower 41 and the drying chamber 2, a primary air suction passage 6 is connected between the primary heating device 41 and the drying chamber 2, and hot air circulation is thus formed among the primary air blower 41, the primary heating device 41 and the drying chamber 2. Hot air after being heated by the heating device is sucked away by the primary air blower 41 and blown into the drying chamber 2 from the primary air blowing passage 5. Moreover, the air intake direction of the primary air blowing passage 5 is parallel to the axial direction of the delivering rollers 12 so as to make hot air and the thin film 13 parallel to each other and prevent the thin film 13 from undergoing large shaking caused by hot air's blowing the thin film 13 directly. Furthermore, the primary air blowing passage 5 is disposed on the printing surface of the thin film 13 (this printing surface refers to the surface of the currently printed thin film 13), such that hot air dries the thin film more directly while carrying thermal energy into the drying chamber 2.

The primary air suction passage 6 is likewise disposed on the printing surface of the thin film 13. Airflow in the drying chamber 2 is drawn away by the primary air suction passage 6, thus preventing air pressure in the drying chamber 2 from being so high as to oppress the thin film 13. The airflow flows out from the opening through which the thin film 13 enters the drying chamber 2, which effectively improves drying effects.

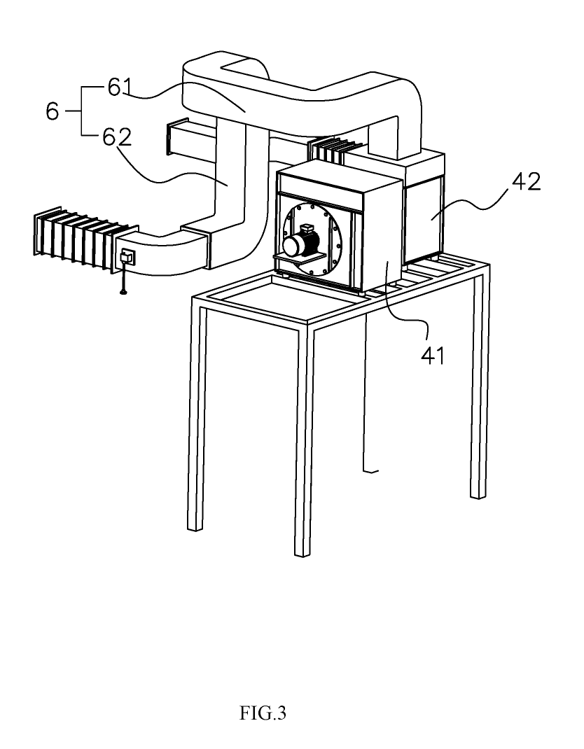

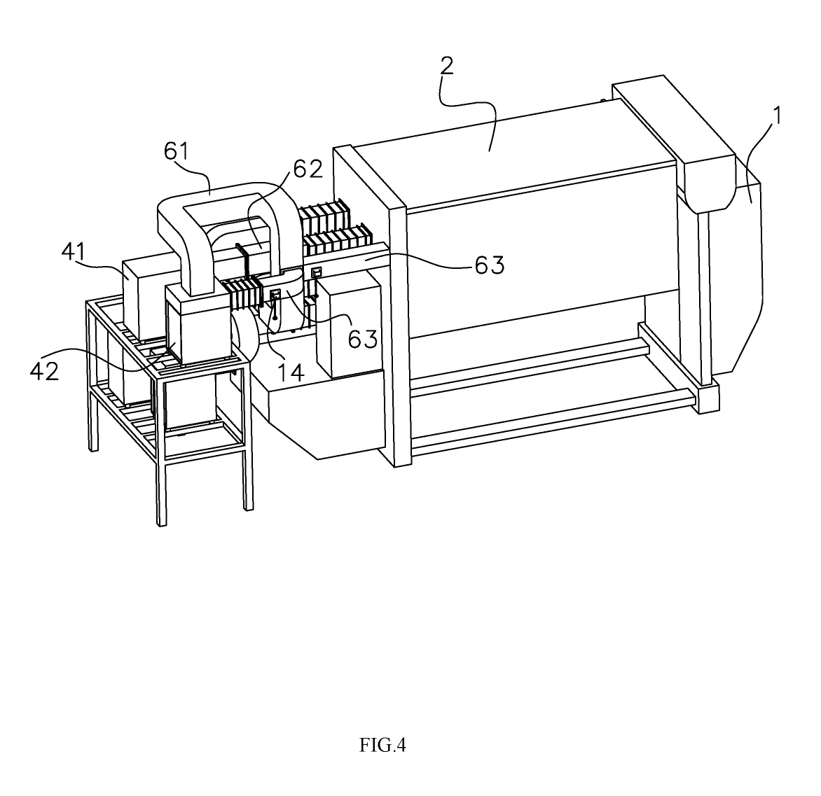

Embodiment 2: a thin film printing production line is provided. Based on the structure in the embodiment, and referring to FIGS. 3 and 4, its primary air blowing passage 5 comprises a first buffer section 61 and a second buffer section 62 that are connected with each other. One end of the first buffer section 61 is connected on the top of a primary heating device 41, and on a horizontal plane, the first buffer section 61 is disposed in a U shape. One end of the first buffer section 61 that is away from the primary heating device 41 extends downward, and on a vertical plane, this section is likewise disposed in a U shape. In other words, another U-shaped tube is formed, and this U-shaped portion is the second buffer section 62. As shown in the figure, the first buffer section 61 and the second buffer section 62 share a portion of the pipeline for the purpose of saving occupation space. One end of the second buffer section 62 that is away from the first buffer section 61 is connected with a drying chamber 2. Airflow drawn out from the drying chamber 2 will collide with the left, right and top tube walls during its circulation in the first buffer section and the second buffer section 62, and the first buffer section 61 and the second buffer section 62 are located outside of the drying chamber 2. As the temperature of the two sections is significantly lower than that of the airflow flowing out of the drying chamber 2, water vapors in this portion of re-flowing airflow condense in the first buffer section 61 and the second buffer section 62, and are prevented from continuing to flow into the primary heating device 41, thereby reducing the humidity of airflow in the hot air circulating system.

However, similarly, the disposition of the first buffer section 61 and the second buffer section 62 leads to the reduction in kinetic energy of the re-flowing airflow. Consequently, this might lead to insufficiency of airflow supply in the primary air blower 41, thus causing the primary air blower 41 to be sucked by airflow in a reverse direction. Therefore, a straight tube 1163 is additionally disposed in the drying chamber 2. This straight tube 1163 is in communication with the second buffer section 62, and extends to connect to the primary heating device 41. The straight tube 1163 is also provided thereon with a control valve 14 for controlling the opening and closing of the straight tube 1163. When the air supply of the primary air blower 41 is insufficient, the straight tube 1163 is opened, such that re-flowing airflow directly passes over the first buffer section 61, and enters the primary heating device 41 so as to guarantee the air supply of the primary air blower 41. In actual tests, in order to ensure the air supply of the primary air blower 41, intermittent opening of the straight tube 1163 is often required. Therefore, the control valve 14 on the straight tube 1163 is disposed to be a solenoid valve to make it open automatically in an intermittent manner.

Embodiment 3: a thin film printing production line is provided, which comprises a plurality of printing presses 1. A drying chamber 2 is disposed above each of the printing presses 1, and the drying chamber 2 is provided therein with a plurality of delivering rollers 12 for transferring a thin film 13 after printing.

A hot air circulating system is mounted on the lateral side of each of the printing presses 1, and the system comprises a primary circulation system and an auxiliary circulation system. The primary circulation system comprises a primary air blower 41 and a primary heating device 41. The primary heating device 41 using thermocouple as its heating source is connected at an air suction opening of the primary air blower 41. A primary air blowing passage 5 is connected between an air blowing opening of the primary air blower 41 and the drying chamber 2, a primary air suction passage 6 is connected between the primary heating device 41 and the drying chamber 2, and hot air circulation is formed among the primary air blower 41, the primary heating device 41 and the drying chamber 2. The air intake direction of the primary air blowing passage 5 is parallel to the axial direction of the delivering rollers 12. Moreover, the primary air blowing passage 5 is disposed on the printing surface of the thin film 13. The primary air suction passage 6 is likewise disposed on the printing surface of the thin film 13.

The auxiliary circulation system is disposed below the primary circulation system, and the auxiliary circulation system comprises a secondary air blower 7, a secondary heating device 8, a secondary air blowing pipe and a secondary air intake pipe. The structure of the auxiliary circulation system is basically the same as that of the primary circulation system. Moreover, the primary air suction passage 6 is longer than the primary air blowing passage 5, and the secondary air suction passage 10 is longer than the secondary air blowing passage. This structure is utilized to further disperse and reduce the suction force of the air suction passage towards the thin film 13.

In the drying chamber 2, the thin film 13 is inclined for delivering. Besides, the primary air blowing passage 5 is located above the back of the thin film 13, while the secondary air blowing passage 9 is located below the back of the thin film 13. The power or frequency of the primary air blower 41 and the secondary air blower 7 is adjusted respectively to achieve different degrees of drying effects on different parts of the thin film 13.

Embodiment 4: a thin film printing production line is provided. The printing production line for a thin film 13 comprises a plurality of printing presses 1. A drying chamber 2 is disposed above each of the printing presses 1, and the drying chamber 2 is provided therein with a plurality of delivering rollers 12 for transferring the thin film 13 after printing.

A hot air circulating system is mounted on the lateral side of each of the printing presses 1, and the system comprises a primary circulation system and an auxiliary circulation system. Here, the primary circulation system comprises a primary air blower 41 and a primary heating device 41. The primary heating device 41 using thermocouple as its heating source is connected at an air suction opening of the primary air blower 41. A primary air blowing passage 5 is connected between an air blowing opening of the primary air blower 41 and the drying chamber 2, a primary air suction passage 6 is connected between the primary heating device 41 and the drying chamber 2, and hot air circulation is formed among the primary air blower 41, the primary heating device 41 and the drying chamber 2. Moreover, the primary air suction passage 6 is provided thereon with an air discharging pipe for discharging air to the outside of a workshop. Similarly, the discharging pipe is not only one in number. Explanation is made below with one discharging pipe as an example. Airflow is heated by the primary heating device 41, and then blown by the primary air blower 41 into the drying chamber 2. After drying the thin film, the airflow flows from the primary air suction passage 6 to the primary heating device 42. In this manner, while the primary air blower 41 is supplying air to the drying chamber 2, the airflow in the primary air suction passage 6 is heated again therein and then flows into the primary air blowing passage 5, thereby improving drying effects on the thin film through the method that maintains a low temperature but increases the amount of air. The primary air suction passage 6 is provided thereon with the air discharging passage connected to outer ends of a workshop and used for discharging some of the airflow when printing dust accumulated in the circulating airflow is excessive so as to ensure production safety. The air intake direction of the primary air blowing passage 5 is parallel to the axial direction of the delivering rollers 12. Moreover, the primary air blowing passage 5 is disposed on the printing surface of the thin film 13. The primary air suction passage 6 is likewise disposed on the printing surface of the thin film 13.

The auxiliary circulation system is disposed below the primary circulation system, and the auxiliary circulation system comprises a secondary air blower 7, a secondary heating device 8, a secondary air blowing pipe and a secondary air intake pipe. The structure of the auxiliary circulation system is basically the same as that of the primary circulation system. In the drying chamber 2, the thin film 13 is inclined for delivering.

The primary air blowing passage 5 comprises a first buffer section 61 and a second buffer section 62 that are connected with each other. One end of the first buffer section 61 is connected on the top of the primary heating device 41, and on a horizontal plane, the first buffer section 61 is disposed in a U shape. One end of the first buffer section 61 that is away from the primary heating device 41 extends downward, and on a vertical plane, this section is likewise disposed in a U shape. In other words, another U-shaped tube is formed, and this U-shaped portion is the second buffer section 62. One end of the second buffer section 62 that is away from the first buffer section 61 is connected with the drying chamber 2.

A straight tube 1163 is additionally disposed in the drying chamber 2. This straight tube 1163 is in communication with the second buffer section 62, and extends to connect to the primary heating device 41. The primary air blowing passage 5, the primary air suction passage 6, the secondary air blowing passage 9, the secondary air suction passage 10 and the straight tube 1163 are each provided thereon with a solenoid control valve 14 for controlling the opening and closing of these pipelines. The primary air blower 41 and the secondary air blower 7 are disposed to be frequency-modulated air blowers. The printing unit is additionally provided with a power distribution control box having a PLC control module 3. The PLC control module is utilized to achieve centralized control over the operation conditions of various solenoid valves, the primary air blower 41 and the secondary air blower 7. In this manner, the control over specific operation conditions of various components of the hot air circulating system in the printing unit is achieved, and the establishment of an intelligentized workshop is realized. Siemens PLC_S7-200 is adopted for the PLC module, and as this PLC module belongs to the prior art, it will not be described herein in detail.

Specific embodiments are merely explanations of the present invention, and do not constitute any limitations to the present invention. Upon reading this description, those skilled in the art may make modifications with no inventive contributions to these embodiments as required, and these modifications will be protected by the Patent Law as long as they are within the scope of the claims of the present invention.

What is claimed is:

1. A hot air circulating system for printing press, wherein the hot air circulating system for printing press comprises a plurality of primary air blowers (41) and a plurality of primary heating devices (42) connected at air suction openings of the primary air blowers (41), characterized in that: air blowing openings of the primary air blowers (41) are in communication with printing presses (1) through primary air blowing passages (5), and primary air suction passages (6) are connected between the primary heating devices (42) and the printing presses (1).

2. The hot air circulating system for printing press according to claim 1, characterized in that: the primary air suction passages (6) comprise first buffer sections (61) bent as U-shaped.

3. The hot air circulating system for printing press according to claim 2, characterized in that: the first buffer sections (61) are horizontally disposed, wherein one end of each first buffer section (61) is connected on the primary heating device (42), while the other end is connected to a vertically disposed L-shaped tube to form second buffer sections (62), wherein the second buffer sections (62) are connected with the printing presses (1).

4. The hot air circulating system for printing press according to claim 3, characterized in that: the second buffer sections (62) are connected with the primary heating devices (42) through straight tubes (63), wherein the straight tubes (63) are provided thereon with pressure regulating valves for opening and closing the straight tubes (63).

5. The hot air circulating system for printing press according to claim 4, characterized by further comprising a plurality of secondary air blowers (7) and a plurality of secondary heating devices (8) connected at air suction openings of the secondary air blowers (7), wherein the air blowing openings of the secondary air blowers (7) are in communication with the printing presses (1) through secondary air blowing passages (9), and the secondary heating devices (8) are in communication with the printing presses (1) through secondary air suction passages (10).

6. The hot air circulating system for printing press according to claim 5, characterized in that: the printing presses (1) are provided therein with carrying roller groups for delivering thin films (13), wherein front surfaces of the thin films (13) are printing surfaces, wherein each primary air blowing passage (5) and each secondary air blowing passage (9) are located on one side of the printing surface of the thin film (13), and each primary air suction passage (6) and each secondary air suction passage (10) are likewise located on one side of the printing surface of the thin film (13).

7. The hot air circulating system for printing press according to claim 6, characterized in that: the primary air blowing passages (5), the secondary air blowing passages (9), the primary air suction passages (6) and the secondary air suction passages (10) are provided thereon with flow control valves (14), respectively.

8. The hot air circulating system for printing press according to claim 7, characterized in that: the primary air suction passages (6) are provided thereon with a plurality of air discharging pipes for discharging air to the outside of a workshop.

9. The hot air circulating system for printing press according to claim 8, characterized in that: the air discharging pipes are also provided thereon with flow control valves (14).

10. The hot air circulating system for printing press according to claim 9, characterized in that: the flow control valves (14) are solenoid valves; and the hot air circulating system for printing press is also provided with a PLC control module (3) used for controlling the flow control valves (14) and adjusting the frequencies of the primary air blowers (41), the primary heating devices (42), the secondary air blowers (7) and the secondary heating devices (8).
